(19) United States
(12) Patent Application Publication
(10) Pub. No.: US 2005/0094839 A1
(43) Pub. Date: May 5, 2005

(54) Earpiece set for the wireless communication apparatus

(76) Inventor: Lin Klar Gwee, (US)

Correspondence Address: RUBEN C. DELEON;WINSTEAD SECHROST & MINICK P.C., P.O. BOX 50784, DALLAS, TX, 75201, US

(21) Appl. No.: 10/702,005

(22) Filed: Nov. 5, 2003

(51) Int. Cl. H04R 25/00

(52) U.S. Cl. 381/381; 381/370

(57) ABSTRACT

The present invention provides an improved earpiece set for the wireless communication apparatus and the provided earpiece set is applicable to blue-tooth communication systems. The present invention comprises a supporting neck and one earpiece. The supporting neck is used to support the wireless communication apparatus and mount it to one of the user's ears. The earpiece connects with the supporting neck such that the earpiece can move freely with the supporting neck.

### BACKGROUND OF THE INVENTION

1. Field of the Invention

The present invention is related to a communication apparatus, and more particularly, to an earpiece set of the wireless communication apparatus.

2. Description of the Prior Art

As the fast innovation of electronic technology, both hardware and software improves quickly and continuously. For example, the input and output interface of various mobile communication systems has changed from the conventional direct-speaking/hearing mode into wired and wireless communication apparatus. Direct speaking and hearing used for communication for centuries has gradually caused many inconveniences, such as the case when one needs to speak with his hands busy. Therefore, there is more and more demand for dispensing with hand-held devices in wired or wireless communication. Current mobile communication apparatus are mostly in one-unity form, which often causes limitations on the wearing position and reduces convenience in application. To solve this problem, it is necessary to develop two modules for the device body to suit both the left and right human ear, but this will increase the manufacturing cost. Accordingly, conventional communication apparatus are still not able to satisfy the user with comfort and easiness at the same time. Obviously, despite great progress in modern electronic technology, the design of current communication apparatus still confines the convenience of mobile communication system to some level.

### SUMMARY OF THE INVENTION

In accordance with the present invention, a new earpiece set of the wireless communication apparatus is provided that substantially overcomes the drawbacks of above problems mentioned from the conventional system.

One object of the present invention is to provide an earpiece set of the wireless communication apparatus. The earpiece set in the present invention has an earpiece connecting with a supporting neck such that the earpiece can move freely to fit separate user's ear. Furthermore, the earpiece set in the present invention also reduces the manufacturing cost by simplifying conventional manufacturing processes. Therefore, the present invention corresponds to economic effect and utilization in industry.

Accordingly, the present invention provides an improved earpiece set of the wireless communication apparatus and the earpiece set is applicable to blue-tooth communication systems. The present invention comprises a supporting neck and one earpiece. The supporting neck is used to support the wireless communication apparatus and mount it to one of the user's ears. The earpiece connects with the supporting neck such that the earpiece can move freely with the supporting neck. Furthermore, the present invention provides a new packaging mechanism for the earpiece, which comprises said supporting neck, a first packaging case, and a second packaging case. The first packaging case has a first rotating device and the second packaging case has a second rotating device; the second rotating device connects with the first rotating device such that the second rotating device can rotates on the top of the first rotating device. The end of the supporting neck extends out and covers the surface of the first packaging case, leaving the first rotating device exposed. The second packaging case further comprises a first bowl-shaped device with a first open mouth and a second bowl-shaped device with a second open mouth, wherein the above-mentioned second rotating device is on the outside surface of the first bowl-shaped device. The first open mouth of the first bowl-shaped device correspondingly engage a the second open mouth of the second bowl-shaped device to form a closed room for accommodating needed electronic elements.

### BRIEF DESCRIPTION OF THE DRAWINGS

FIG. 1A and FIG. 1B are block diagrams illustrating the structures of the earpiece set in one embodiment of the present invention; and

FIG. 2A to FIG. 2C are block diagrams illustrating the structures of the earpiece set in another embodiment of the present invention.

### DESCRIPTION OF THE PREFERRED EMBODIMENT

The present invention is related to a wireless communication apparatus. The architecture and working mechanism will now be described in greater detail to make the present invention more readily appreciated. Obviously, the present invention should not be limited in the details known to those skilled in the art, and well-known devices will not be described herein to avoid unnecessary limitations.

Preferred embodiments of the present invention will now be described. Nevertheless, It should be recognized that the present invention can be practiced in a wide range of other embodiments besides those explicitly described herein, and the scope of the present invention is expressly not limited except as specified in the accompany claims.

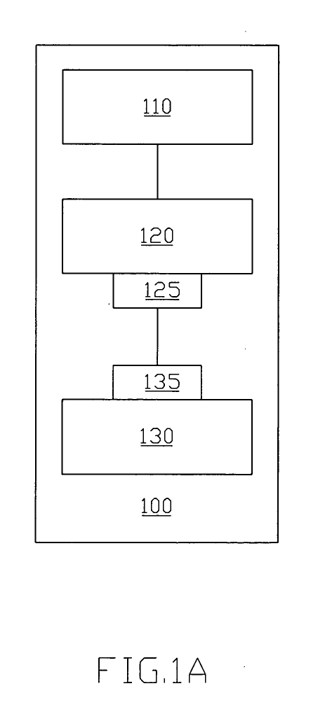

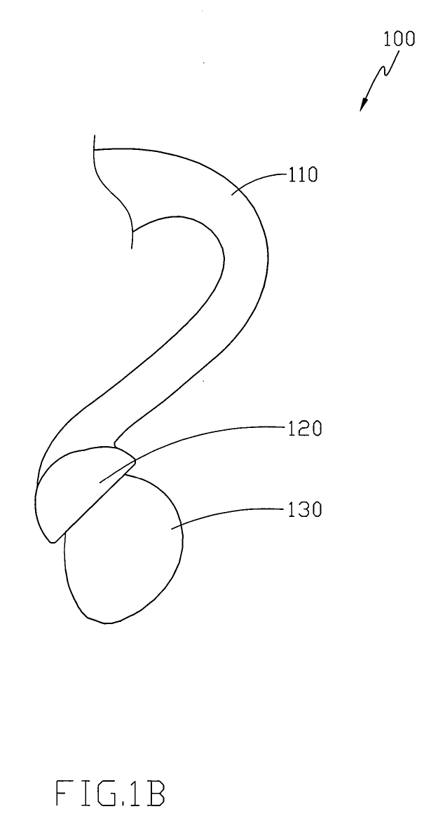

Referring to FIG. 1A and FIG. 1B, in one embodiment of the present invention, an earpiece set for the wireless communication apparatus 100 is provided. The earpiece set for the wireless communication apparatus 100 comprises a supporting neck 110 for supporting the earpiece set 100 and mounting it to one of the user's ears; a first packaging case 120; and a second packaging case 130. The supporting neck 110 contains inside needed wires. The supporting neck 110 connects with the second packaging case 130 by the first packaging case 120 such that the earpiece can move freely with the supporting neck 110. The second packaging case 130 has a closed room inside for accommodating the electrical devices needed such as the device for generating voice; furthermore, there is a plurality of holes designed for amplifying voice on the outside surface of the second packaging case 130. The first packaging case 120 has a first rotating device 125 and the second packaging case 130 has a second rotating device 135; the first rotating device 125 connects with the second rotating device 135 such that the second packaging case 130 can rotate on the top of the first packaging 120; each of the first rotating device 125 and the second rotating device 135 further comprises a rail set. Furthermore, the end of the supporting neck 110 extends out and cover the surface of the first packaging case 120, leaving the first rotating device 125 exposed.

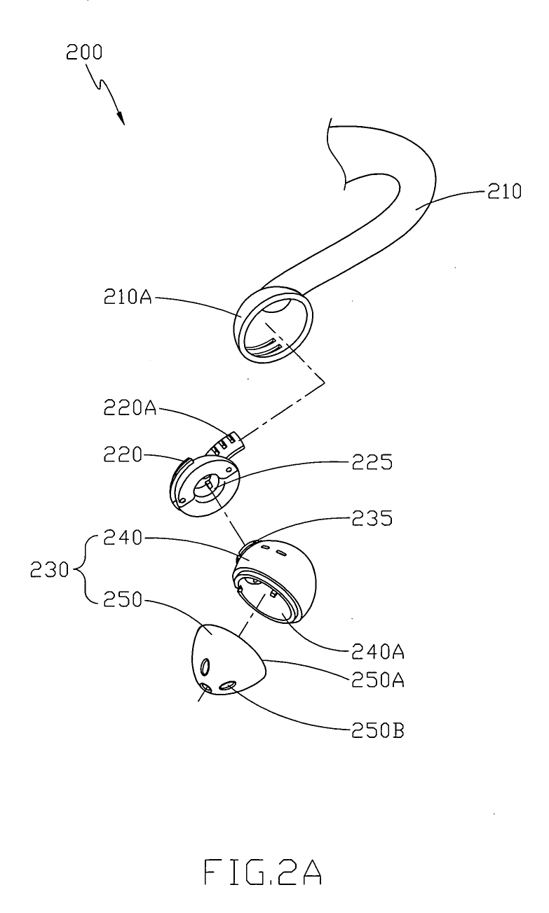

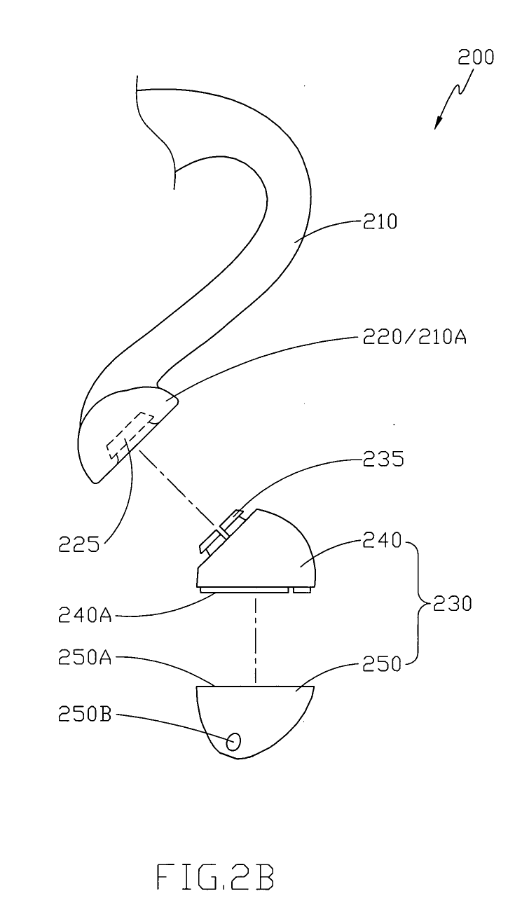

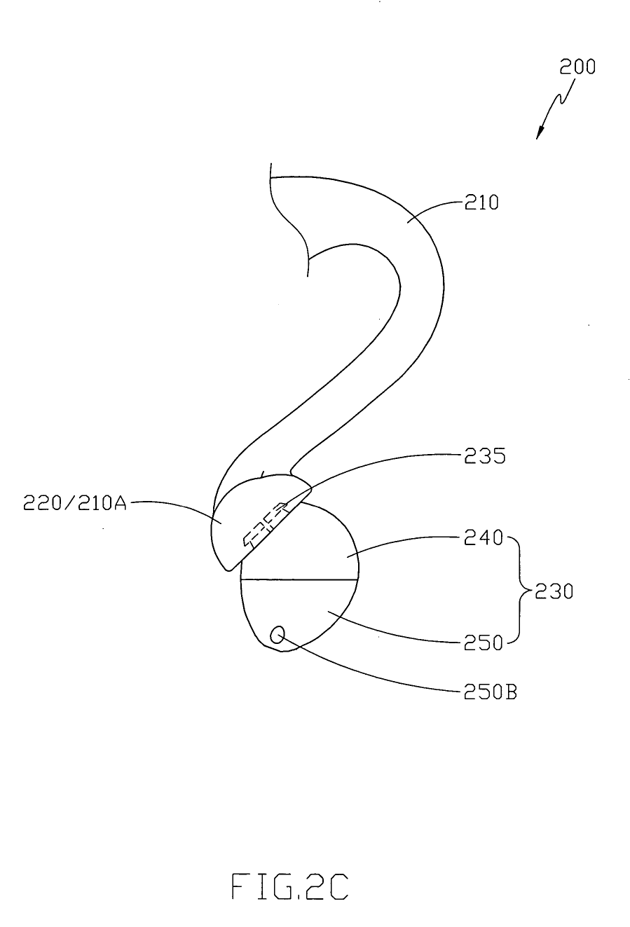

Referring to FIG. 2A, FIG. 2B and FIG. 2C, in another embodiment of the present invention, an earpiece set for the wireless communication apparatus 200 is provided. The earpiece set for the wireless communication apparatus 200 comprises a supporting neck 210 for supporting the earpiece set 200 and mounting it to one of the user's ears; a first packaging case 220; and a second packaging case 230. The supporting neck 210 contains inside needed wires.

The first packaging case 220 has a rotating fillister 225 and one end 220A; the second packaging case 230 has a protruding body 235. The rotating fillister 225 connects with the protruding body 235 by the rail sets on the inside surface of the rotating fillister 225 and the outside surface of the protruding body 235 such that the second packaging case 230 can rotate on the top of the first packaging case 220. Furthermore, the end of the supporting neck 210, 210A, extends along the end of the first packaging case 220, 220A, and covers the surface of the first packaging case 220, leaving the first rotating fillister 225 exposed. The end of the first packaging case 220, 220A, is plugged into the supporting neck 210 for fixing a plurality of wires and introducing them into the first packaging case 220 and the second packaging case 230. The second packaging case 230 further comprises a first bowl-shaped device 240 with a first open mouth 240A and a second bowl-shaped device 250 with a second open mouth 250A; the protruding body 235 mentioned above is set on the outside surface of the first bowl-shaped device 240. The first open mouth 240A of the first bowl-shaped device 240 correspondingly engages the second open mouth 250A of the second bowl-shaped device 250 to form a closed room for accommodating the electronic elements needed such as the device for generating voice; furthermore, there is a plurality of holes 250B designed for amplifying voice on the outside surface of the second bowl-shaped device 250.

As described above, in accordance of the prevent invention, the earpiece set for the wireless communication apparatus provided herein has an earpiece connecting with the supporting neck such that the earpiece can move freely with the supporting neck, which enables the earpiece set to fit in both the left and the right human ears. This feature further enables the user to wear the provided earpiece set both tightly and comfortably. Furthermore, the present invention is important to the manufacturing process in that it can use only one set of module to meet various specifications, which hugely reduces the manufacturing cost. Therefore, the present invention corresponds to economic effect and the utilization in industry. The present invention is applicable to blue-tooth communication systems and many other wireless mobile communication systems.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

1. An earpiece set for the wireless communication apparatus, comprising:
a supporting neck to support said earpiece set and mount said earpiece set to one of the user's ears;
a first packaging case with a first rotating device wherein the end of said supporting neck extends out and covers the surface of said first packaging case, leaving said first rotating device exposed; and
a second packaging case with a second rotating device wherein said second rotating device connects with said first rotating device such that said supporting neck is able to connect with said second packaging case through said first packaging case and that said second packaging case is able to rotate on the top of said first packaging case.

2. The earpiece set for the wireless communication apparatus according to claim 1, wherein said second packaging case comprises inside closed room for accommodating electronic elements needed.

3. The earpiece set for the wireless communication apparatus according to claim 1, further comprising a plurality of holes designed for amplifying voice on the outside surface of said second packaging case.

4. The wireless communication apparatus according to claim 1, wherein each of said first rotating device and said second rotating device further comprises a rail set.

5. An earpiece set for the wireless communication apparatus, comprising:
a supporting neck, said supporting neck contains inside wires and said supporting neck is used for supporting said earpiece set and mounting said earpiece set to one of the user's ears;
a first packaging case with a rotating fillister and one end, wherein the end of said supporting neck extends out along said end of said first packaging case and covers the surface of said first packaging case, leaving said rotating fillister exposed; and
a second packaging case with a protruding body, wherein said rotating fillister connects with said protruding body by a plurality of rail sets on the inside surface of said rotating fillister and the outside surface of said protruding body such that said second packaging case can rotate on the top of said first packaging case.

6. The earpiece for the wireless communication apparatus according to claim 5, wherein the end of said first packaging case is plugged into said supporting neck so as to fix said wires and introduce them into said first packaging case and said second packaging case.

7. The earpiece for the wireless communication apparatus according to claim 5, wherein said second packaging case further comprises:
a first bowl-shaped device with a first open mouth, wherein said first bowl-shaped device has said protruding body on the outside surface of said first bowl-shaped device; and
a second bowl-shaped device with a second open mouth, wherein said second open mouth of said second bowl-shaped device correspondingly engages said first open mouth of said first bowl-shaped to form a closed room for accommodating electronic elements needed.

8. The wireless communication apparatus according to claim 7, further comprising a plurality of holes designed for amplifying voice on the outside surface of said second bowl-shaped device.
